(19) United States
(12) Patent Application Publication
(10) Pub. No.: US 2006/0163779 A1
(43) Pub. Date: Jul. 27, 2006

(54) Method and device for producing an injection moulded article, to the external peripheral surface of which an element, e.g.a label is applied

(76) Inventor: Peter Zimmerman, Grasbrunn (DE)

Correspondence Address: KNOBBE MARTENS OLSON & BEAR LLP, 2040 MAIN STREET, FOURTEENTH FLOOR, IRVINE, CA, 92614, US

(21) Appl. No.: 10/521,046

(22) PCT Filed: Jul. 11, 2003
(86) PCT No.: PCT/EP03/07550

§ 371 Date: Dec. 27, 2005

(30) Foreign Application Priority Data
Jul. 12, 2002 (DE) 102 31 654.6

(51) Int. Cl. B29C 43/22; B32B 37/00

(52) U.S. Cl. 264/509; 264/513

(57) ABSTRACT

During injection molding of injection molded articles on which an application, for example, a label, is attached, the label is preformed in a preforming means and transferred by a transfer tool into the injection molding machine for increasing the cycle rate of the injection molding machine.

The invention relates to a method according to the preamble of claim 1 and an apparatus according to the preamble of claim 2.

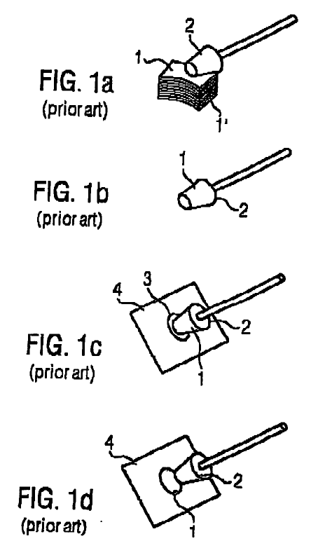

From EP 802 032, there are known a method and an apparatus of this kind for injection molding a beaker having a label on the outer circumference. FIG. 1 shows, in step a, the taking up of a label 1 by a truncated cone-shaped transfer tool 2 from a pile of labels 1′, wherein the truncated cone, which is provided on the outer circumference with an electrically conductive layer and vacuum bores, is rolled onto the label using vacuum application, so that the label abuts around the circumference of the truncated cone as shown in step b. Hereupon, in step c the label is transferred into a mold cavity 3 of an injection molding tool 4 of the injection molding machine, wherein after insertion of the truncated cone-shaped transfer tool in the mold cavity, voltage is applied to this tool such that the label is electrostatically charged and fixedly held on the inner circumferential area of the mold cavity by the electrostatic charge. Hereupon, in step d the transfer tool is moved back out of the mold cavity 3, in which the label 1 remains, whereupon the mold is closed and the injection molding process can be carried out.

In this known method, the transfer tool requires a certain amount of time for rolling the label before the transfer tool can be moved into the mold cavity, while the injection molding process itself proceeds relatively quickly. Therefore the injection mold must be passively held in readiness for a certain time while the label is rolled onto the transfer tool and delivered to the mold cavity. Due to this long cycle rate for taking up and rolling the label by means of the transfer tool in relation to the cycle rate of the injection molding machine, the capacity of the latter cannot be fully exploited.

The invention is based on the object of adapting a method of the type given above such that the capacity of the injection molding machine can be better exploited. Further, an apparatus is to be proposed by means of which an increase in capacity of the injection molding machine can be achieved.

This object is solved for the method by the features in the characterizing part of claim 1. Before the label is positioned on the circumference of the transfer tool, it is moved into a preforming means and shaped for insertion into the mold cavity. This allows the transfer tool to receive the label from the preforming means and transfer it to the mold cavity at a fast cycle rate, so that during the transfer of a label from the preforming means to the mold cavity of the injection molding tool, a further label can already be preformed in the preforming means and held in readiness to be taken up by the transfer tool. Altogether, the provision of a preforming process of the label allows a higher cycle rate to be used, which allows the injection molding machine to work at a high capacity.

The object of increasing the capacity of an injection molding machine is solved by a preforming means by means of which the label is preformed before being transferred into the mold cavity, so that it can be merely taken over by the transfer tool and delivered to the mold cavity without any loss of time.

An exemplary embodiment of the invention in explained in more detail below with reference to the drawing in which

FIG. 1 shows the individual steps for transferring a label into the mold cavity using the known method,

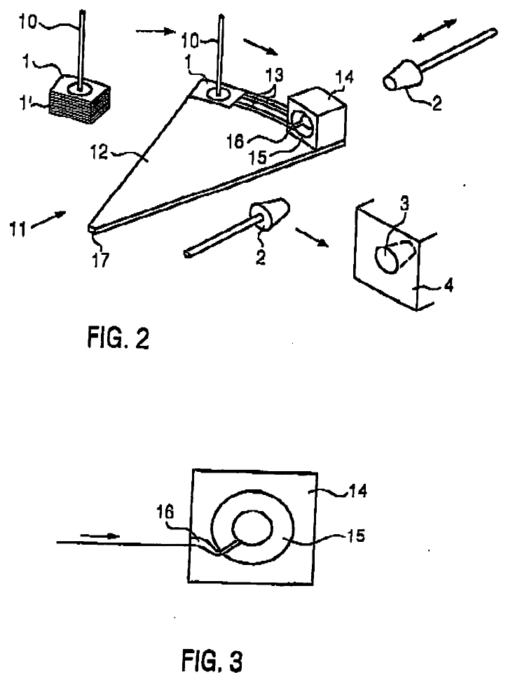

FIG. 2 shows a corresponding representation of the sequence of steps for the method according to the invention using a preforming means,

FIG. 3 shows a front view of the preforming block, and

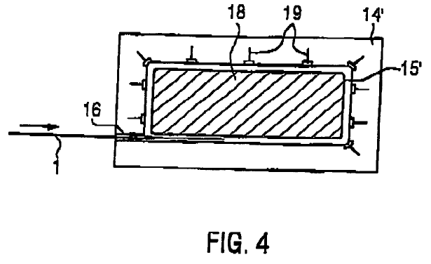

FIG. 4 shows schematically a supporting core in the preform.

In contrast to the known method shown in FIG. 1 in which the transfer tool itself brings the label into the shape in which it can then be inserted in the mold cavity 3, in the method according to the invention in an extra step the label is preformed such that it can be merely taken up by the transfer tool and inserted into the mold cavity 3 of the injection molding tool 4.

FIG. 2 schematically shows the procedure for this method. Firstly, a gripper 10, which is for example vacuum-applied, takes a label 1 from a pile of labels 1′ and transfers it in the direction of the arrow to a preforming means 11 having a sector-shaped plate 12. On this plate 12 circular arc-shaped guideways 13 are formed, in which vacuum-applicable grippers (not shown) are displaceably guided for taking over the label 1 from the gripper 10 and guiding it to a forming block 14, whose preform cavity 15 corresponds to the model cavity 3 of the injection molding tool 4. The forming block 14 is provided adjacent to the guideways 13 with a slit 16 extending in the axial direction of the preform cavity 15, through which slit the label is introduced into the preform cavity 15, in which it abuts along the truncated cone-shaped inner circumferential wall. As soon as the label is positioned on the inner circumference of the preform cavity 15, the truncated cone-shaped transfer tool 2 is moved into the preform cavity 15, whereupon using vacuum application of the transfer tool 2 the label is taken up and transferred into the mold cavity 3 of the injection molding tool 4. The bores and channels on the transfer tool 2 for vacuum application are not shown in FIG. 2.

While the preformed label is being transferred by means of the transfer tool 2 from the preforming means 11 to the mold cavity of the injection molding machine, a further label can already be picked up from the pile 1′ and transferred into the preforming means 11, so that after closing of the injection mold 4 and the injection molding process, a further preformed label is already held in readiness for the transfer tool 2, and altogether a higher cycle rate can be used.

To allow the label to be preformed in a form corresponding to a truncated cone-shaped beaker, the label 1 is cut to the shape of a section of a ring sector is moved onto a circular arc track around a center 17 of a circle, wherein the radius of the guideway 13 corresponds to the radius of the curvature of the label. In other words, the label 1 on the circular arc-shaped guideway 13 represents a development of the inner circumference of the preform cavity 15.

To allow the label to slide along the inner circumference of the preform cavity 15 when inserted in the slit 16 of the forming block 14, a guide sheet (not shown in FIG. 2) can be provided at the slit to serve as a guide for the label. The guideway 13 can extend up to the slit 16 and if necessary also around the inner circumference of the preform cavity, to assist or guarantee the rolling of the label by the gripper guided in the guideway.

It is also possible to form the slit 16 curved so that it opens into the preform cavity 15 approximately tangentially to the inner circumferential wall of the preform cavity 15, to assist the abutting of the label on the inner wall of the preform cavity. FIG. 3 shows an example of an insertion slit 16 curved in this way, in a view of the preform cavity 15 from the side of the engagement of the transfer tool 2.

Instead of the described preforming means 11, depending on another shape of an injection molded article, other preforming means can also be provided. Correspondingly, the provision of a preforming means can also be used for the fabrication of a differently shaped injection molded article on whose outside a label or another application is to be attached.

If, for example, large injection molded articles are provided, such as buckets or injection molded articles having a long side length, for example an approximately rectangular container, then it is advantageous to support the preforming process by an auxiliary means.

FIG. 4 shows a forming block 14′ having an approximately rectangular preform cavity 15′. The slit 16 opens along a longitudinal side of the preform cavity for inserting the label 1. So that the label 1 is better guided along the narrow radii at the corners and over the larger sidelengths of the preform cavity, a supporting core 18 is provided which is inserted in the preform cavity 15′ only during the preforming procedure. Hereby, along the circumference of the preform cavity 15′ a gap is formed, through which the label 1 is guided.

The supporting core 18 can be inserted in the preform and removed again after the preforming process by means of a gripper (not shown), so that the transfer tool 2 can engage for taking up the preformed label. Hereby, the supporting core 18 can be moved in and out through the one or other side of the preform, which is open on both sides.

FIG. 4 shows suction means 19, for example bores, which are vacuum applied and arranged at least partially around the circumference of the preform cavity 15′. After preforming and removal of the supporting core 18, by means of these suction means 19 the label can be held closely abutting on the preform. Such suction means 19 can be provided for example only on the long sides and especially on the narrow radii of the preform cavity 15′ in connection with a supporting core 18 or without a supporting core 18.

Applications or labels preformed in other ways can also be inserted in an already preformed state into the preform 14, 15 and then transformed by the transfer tool 2 into the mold cavity 3 of the injection molding tool. In this way, an increase in the cycle rate of the injection molding machine is achieved.

1. Method for fabricating an injection molded article, for example a beaker, on whose outer circumference an application, for example a label, is arranged, comprising the following steps:
providing an injection mold having two mold halves which, in the closed state, form a mold cavity corresponding to the shape of the article to be fabricated,
placing the label on a transfer tool,
transferring the label into the mold cavity of the one mold half using the transfer tool,
whereupon after positioning of the label in the mold cavity the transfer tool is moved out of the mold cavity and the mold halves are closed for injection molding, characterized in that
the label is preformed into the shape for insertion into the mold cavity before it is placed on the transfer tool, and
is transferred by the transfer tool into the mold cavity.

2. Device for fabricating an injection molded article, for example a beaker, on whose outer circumference an application, for example a label, is arranged, comprising:
an injection mold having two mold halves which, in the closed state, form a mold cavity corresponding to the shape of the article to be fabricated, and
a transfer tool configured such that the label is transferable into the mold cavity of a mold half, characterized in that
a preformer configured to preform the label substantially into the shape in which the label is to be inserted in the mold cavity of one mold half,
wherein the transfer tool takes up the preformed label out of the preformer and transfers it to the injection mold.

3. Device according to claim 2, comprising a guideway along which at least one gripper for the label is guided, and a forming block having a preform cavity corresponding to the mold cavity of the injection molding tool, wherein in the forming block a slit is formed near the guideway for taking up the label.

4. Device according to claim 3, in which the guideway is formed curved in a circular arc shape and the preform cavity is formed in a truncated cone shape, wherein the radius of curvature of the guideway lies on the side of the smallest diameter of the preform cavity.

5. Device according to claim 2, wherein a supporting core is insertable in the preform cavity for guiding the label during preforming.

6. Device according to claim 2, wherein at least partially on the inner circumference of the preform cavity suction is provided for holding the label in the preformed shape.

7. Device according to claim 3, wherein a supporting core is insertable in the preform cavity for guiding the label during preforming.

8. Device according to claim 4, wherein a supporting core is insertable in the preform cavity for guiding the label during preforming.

9. Device according to claim 3, wherein at least partially on the inner circumference of the preform cavity suction is provided for holding the label in the preformed shape.

10. Device according to claim 4, wherein at least partially on the inner circumference of the preform cavity suction is provided for holding the label in the preformed shape.

11. Device according to claim 5, wherein at least partially on the inner circumference of the preform cavity suction is provided for holding the label in the preformed shape.

12. Device according to claim 7, wherein at least partially on the inner circumference of the preform cavity suction is provided for holding the label in the preformed shape.

13. Device according to claim 8, wherein at least partially on the inner circumference of the preform cavity suction is provided for holding the label in the preformed shape.
